(19) United States
(12) Patent Application Publication
(10) Pub. No.: US 2005/0172020 A1
(43) Pub. Date: Aug. 4, 2005

(54) Network control system

(75) Inventor: Katsuyuki Koga, Nagano-ken (JP)

Correspondence Address: SUGHRUE MION, PLLC, 2100 PENNSYLVANIA AVENUE, N.W., SUITE 800, WASHINGTON, DC, 20037, US

(73) Assignee: SEIKO EPSON CORPORATION

(21) Appl. No.: 11/035,402

(22) Filed: Jan. 14, 2005

(30) Foreign Application Priority Data
Jan. 16, 2004 (JP) 2004-8675

(51) Int. Cl. G06F 15/173

(52) U.S. Cl. 709/223

(57) ABSTRACT

In a network control system that enables interconnected operation between multiple devices connected to a network, the user selects two devices as desired objects of interconnected operation, among a TV receiver 100, a projector 200, and a printer 500. The user directs and manipulates an infrared remote control 300 toward each of the selected devices to specify the device as an object device of interconnected operation. Each device receives an infrared signal sent from the infrared remote control 300 and executes control to allow for interconnected operation between specified devices. This arrangement of the invention enables the user to intuitively specify desired devices as objects of interconnected operation without using any special operation window.

### BACKGROUND OF THE INVENTION

1. Field of the Invention

The present invention relates to a network control system that enables interconnected operation of multiple devices connected to a network.

2. Description of the Related Art

Network control systems have been proposed to utilize multiple devices including household electric appliances connected to a network. In the proposed network control system, a menu window or an operation window including icons and buttons for manipulation of multiple devices is displayed on a display unit of a certain device, for example, a home terminal or a TV receiver. The user manipulates the icons and buttons on the menu window or the operation window, and each device is operated according to the user's manipulation. This system enables interconnected operation of multiple devices, for example, copy of a video tape.

Such prior art techniques are disclosed, for example, in Japanese Patent Laid-Open Gazettes No. 9-149325 and No. 2001-45575.

The prior art network control system requires the user to specify desired devices as object devices of interconnected operation on the menu window or on the operation window displayed on the display unit of the certain device. The user may have difficulties in intuitively specifying desired devices as object devices of interconnected operation, especially in a large network connecting with a large number of devices.

### SUMMARY OF THE INVENTION

The object of the invention is thus to eliminate the drawbacks of the prior art systems and to provide a technique of enabling a user to intuitively specify desired devices as objects of interconnected operation without using any special operation window in a network control system that enables interconnected operation of multiple devices connected to a network.

In order to attain at least part of the above and the other related objects, the present invention is directed to a network control system that enables interconnected operation between multiple devices connected to a network. Each of the multiple devices includes: a detection module that detects a user's predetermined operation toward the device as specification of the device as an object device of interconnected operation; and a control module that executes a preset control to allow for interconnected operation between specified devices, in response to the detection.

The user carries out the predetermined operation toward each of desired devices to specify the desired device as an object device of interconnected operation among the multiple devices connected via the network. The predetermined operation is, for example, an ON operation of a preset switch provided on the device or an operation of a remote control toward the device. Each device specified by the user detects the specification as an object device of interconnected operation and executes the preset control to allow for interconnected operation between specified devices. The preset control is, for example, establishment of communication between the specified devices or transmission of various data between the specified devices.

The user carries out the predetermined operation toward multiple desired devices to specify the desired devices as object devices of interconnected operation. This arrangement enables the user to intuitively specify desired devices as object devices of interconnected operation without using any special operation window.

In one preferable embodiment of the network control system of the invention, the detection module may include at least one of a touch sensor that detects the user's touch, a switch that is manipulated by the user, a voice sensor that detects the user's voice, and a receiver that receives a signal with directional characteristic, which is sent from a preset remote control that is operated by the user and is capable of transmitting the signal with directional characteristic.

The preset remote control that is capable of transmitting the signal with directional characteristic may be an optical remote control of transmitting infrared ray or another light ray or a remote control of transmitting a sound wave signal or a radio signal with directional characteristic.

In the network control system of the invention, the device detects the user's touch on the touch sensor provided on the device, the user's ON operation of the switch, the user's voice for specifying the device, or the user's operation of the remote control toward the receiver as specification of the device as an object device of interconnected operation.

In another preferable embodiment of the network control system of the invention, the device further includes an identification information output module that outputs identification information for identification of the device at a predetermined timing after the detection.

The device accordingly notifies another device of the user's specification of the device as an object device of interconnected operation. Another device accordingly recognizes the user's specification of the device as an object device of interconnected operation.

In the network control system, the identification information output module may output the identification information at any of various timings. For example, the identification information output module outputs the identification information simultaneously with the detection.

Here the terminology ‘simultaneously with the detection’ implies ‘immediately after the detection’. In the network control system of the invention, the identification information output module may be designed to output identification information to another predetermined device. The identification information output module may alternatively be designed to output identification information to the multiple devices connected with the network by multicast or by broadcast.

In one preferable embodiment of the network control system where the device has the identification information output module, the device further includes an output request reception module that receives an output request of the identification information from another device specified as another object device of interconnected operation. The identification information output module outputs the identification information, in response to reception of the output request.

For example, the identification information output from another device by broadcast may be used as the output request of identification information of the device. The device outputs the identification information of the device, in response to reception of the identification information from another device. The device outputs the identification information of the device to another device that has sent the output request of identification information. The device and another device thus mutually recognize the requirement of interconnected operation.

In still another preferable embodiment of the network control system of the invention, the device further includes an interconnected device identification information reception module that receives interconnected device identification information for identifying another device specified as another object device of interconnected operation, from another device. The control module executes the control, based on the received interconnected device identification information.

The control module perceives another device as another object device of interconnected operation and carries out control to allow for interconnected operation with another device.

In the network control system of the above embodiment where the device has the interconnected device identification information reception module, the device may receive preset data, while another device may send the preset data. In this structure, the device further includes: a send request transmission module that transmits a send request of the preset data to another device corresponding to the interconnected device identification information; and a data reception module that receives the preset data. Another device includes a data transmission module that sends the preset data, in response to the send request.

The device requests preset data to another device and receives the preset data sent from another device in response to the request. For example, when the device is a projector and another device is a TV receiver, the projector requests video data to the TV receiver, receives the video data sent from the TV receiver in response to the request, and projects an image corresponding to the received video data.

In the network control system of the above embodiment where the device has the interconnected device identification information reception module, the device may send preset data, while another device may receive the preset data. In this structure, the device further includes a data transmission module that sends the preset data to another device corresponding to the interconnected device identification information. Another device includes a data reception module that receives the preset data.

The device sends preset data to another device without a send request from another device. Another device receives the preset data from the device without transmitting a send request to the device. For example, when the device is a TV receiver and another device is a projector, the TV receiver sends video data to the projector without a send request from the projector. The projector receives the video data from the TV receiver and projects an image corresponding to the received video data without transmitting a send request to the TV receiver.

In one preferable embodiment of the invention, the network control system where the device has the identification information output module further includes a control device that works to enable interconnected operation of at least two object devices selected among the multiple devices. The control device has: an identification information input module that inputs pieces of the identification information output from the at least two object devices; an interconnected operation setting module that specifies a setting of interconnected operation between the at least two object devices corresponding to the received pieces of the identification information; and a specification information transmission module that sends specification information representing the specified setting of interconnected operation to at least one of the at least two object devices that respectively output the pieces of the identification information. The device further includes a specification information reception module that receives the specification information, and the control module executes the control, based on the received specification information.

The interconnected operation setting module may register a mapping of each setting of interconnected operation to each piece of identification information and may extract the setting of interconnected operation corresponding to an input piece of identification information from the registered mapping. The setting of interconnected operation may be specified by the user's instruction after input of the piece of identification information.

In the structure of this embodiment, the control device mediates interconnected operation between the devices specified by the user. This arrangement desirably relives the process load of each device.

In still another embodiment of the invention the network control system further includes a remote control that is capable of transmitting a signal with directional characteristic. The remote control has: an operation unit that is manipulated by the user to attain the user's predetermined operation toward the device; and a specification signal transmission module that sends a preset specification signal to specify the device as an object device of interconnected operation, in response to the user's manipulation of the operation unit. The device further includes a specification signal reception module that receives the specification signal, and the control module executes the control, based on the received specification signal.

The user operates the remote control toward the device to specify the device as an object device of interconnected operation.

In the network control system of this embodiment, the specification signal transmission module may selectively send one of multiple specification signals according to a type of the user's manipulation of the operation unit.

When the operation unit is a button, the user's manipulation may be, for example, ‘long-press of the button’ ‘double press the button’, and ‘release of the long-pressed button’.

This arrangement enables the user to selectively send one of the multiple specification signals by manipulation of the operation unit of the remote control having the simple structure.

In the network control system of this embodiment, the multiple specification signals may include a signal representing an order of specification of at least two devices as object devices of interconnected operation.

This arrangement enables the user to specify a main object device of interconnected operation among the multiple devices or to specify a data flow from one device to another device. The specification of control is changed over according to the order of specification of at least two devices as object devices of interconnected operation. For ex ample, when a TV receiver is specified first as an object device and a printer is specified second as another object device, the printer prints an image displayed on the TV receiver. In another example, when a printer is specified first as an object device and a TV receiver is specified second as another object device, management information, for example, a print record, under management of the printer is displayed on the screen of the TV receiver.

In the network control system of this embodiment, the device further includes an identification information output module that outputs identification information for identifying the device, and the specification signal transmission module sends a request signal of requesting output of the identification signal.

The device outputs identification information to the remote control, in response to a request from the remote control.

In the network control system of this embodiment, the remote control further includes an identification information reception module that receives the identification information output from the device, which has received the specification signal. The specification signal transmission module sends the identification signal together with the specification signal, in response to the user's manipulation of the operation unit after the identification information reception module has received the identification information.

The specification signal transmission module sends the identification information of the device specified as an object device of interconnected operation, together with the specification signal to another device.

The present invention is also directed to a device that is used in a network control system, which enables interconnected operation between a plurality of the devices connected to a network. The device includes: a detection module that detects a user's predetermined operation toward the device as specification of the device as an object device of interconnected operation; and a control module that executes a preset control to allow for interconnected operation between specified devices, in response to the detection.

The device of this structure attains the network control system of the invention as described above.

The present invention is further directed to a control device that is used in a network control system, which enables interconnected operation between multiple devices connected to a network. The control device includes: an identification information input module that inputs pieces of identification information output from at least two object devices selected among the multiple devices to respectively identify the at least two object devices; an interconnected operation setting module that specifies a setting of interconnected operation between the at least two object devices corresponding to the received pieces of the identification information; and a specification information transmission module that sends specification information representing the specified setting of interconnected operation to at least one of the at least two object devices that respectively output the pieces of the identification information.

This arrangement attains the network control system of the invention having the control device as described above.

The present invention is also directed to a remote control that is used in a network control system, which enables interconnected operation between multiple devices connected to a network, and is capable of transmitting a signal with directional characteristic. The remote control includes: an operation unit that is manipulated by a user to attain the user's predetermined operation toward at least one of the multiple devices; and a specification signal transmission module that sends a preset specification signal to specify the device as an object device of interconnected operation, in response to the user's manipulation of the operation unit.

This arrangement attains the network control system of the invention having the remote control as described above.

The present invention may not have all the characteristics described above, but may be attained by omission of some non-required characteristics or by adequate combination of various characteristics. For example, the device of the invention may have the functions of the control device of the invention. The remote control of the invention may also have the functions of the control device of the invention.

The present invention is not restricted to the network control system or the device, the control device, and the remote control included in the network control system, but is also actualized by diversity of other applications, for example, computer programs that are used to attain the network control system and the respective constituents of the network control system, recording media in which such computer programs are recorded, and data signals that include such computer programs and are embodied in carrier waves. Any of the additional arrangements discussed above are adopted in the respective applications.

In the applications of the invention as the computer programs and the recording media in which the computer programs are recorded, the invention may be given as whole programs to control the operations of the respective systems and devices or as partial programs to exert only the characteristic functions of the invention. Available examples of the recording media include flexible disks, CD-ROMs, DVD-ROMs, magneto-optical disks, IC cards, ROM cartridges, punched cards, prints with barcodes or other codes printed thereon, internal storage devices (memories like RAMs and ROMs) and external storage devices of the computer, and diversity of other computer readable media.

These and other objects, features, aspects, and advantages of the present invention will become more apparent from the following detailed description of the preferred embodiments with the accompanied drawings.

### BRIEF DESCRIPTION OF THE DRAWINGS

FIG. 1 shows the general configuration of a network control system embodying the invention;

FIG. 2 schematically illustrates the configuration of a TV receiver included in the network control system of FIG. 1;

FIG. 3 schematically illustrates the configuration of a projector included in the network control system of FIG. 1;

FIG. 4 schematically illustrates the configuration of an infrared remote control included in the network control system of FIG. 1;

FIG. 5 shows the outline of network control in a first embodiment;

FIG. 6 is a flowchart showing a network control routine executed in the first embodiment;

FIG. 7 shows the outline of network control in a second embodiment;

FIG. 8 schematically illustrates the configuration of a control device included in the network control system of FIG. 1;

FIG. 9 shows the outline of network control in a third embodiment;

FIG. 10 schematically illustrates the configuration of a printer included in the network control system of FIG. 1;

FIG. 11 shows the outline of network control in a fourth embodiment; and

FIG. 12 shows the outline of network control in a fifth embodiment.

### DESCRIPTION OF THE PREFERRED EMBODIMENTS

Some modes of carrying out the invention are discussed below as preferred embodiments in the following sequence:
A. General Configuration of Network Control System
B. First Embodiment
   B1. TV Receiver
   B2. Projector
   B3. Infrared Remote Control
   B4. Network Control
C. Second Embodiment
   C1. Respective Devices
   C2. Network Control
D. Third Embodiment
   D1. Respective Devices
   D2. Control Device
   D3. Network Control
E. Fourth Embodiment
   E1. Respective Devices
   E2. Printer
   E3. Network Control
F. Fifth Embodiment
   F1. Respective Devices
   F2. Network Control
G. Modifications
   G1. Modified Example 1
   G2. Modified Example 2
   G3. Modified Example 3

A. General Configuration of Network Control System

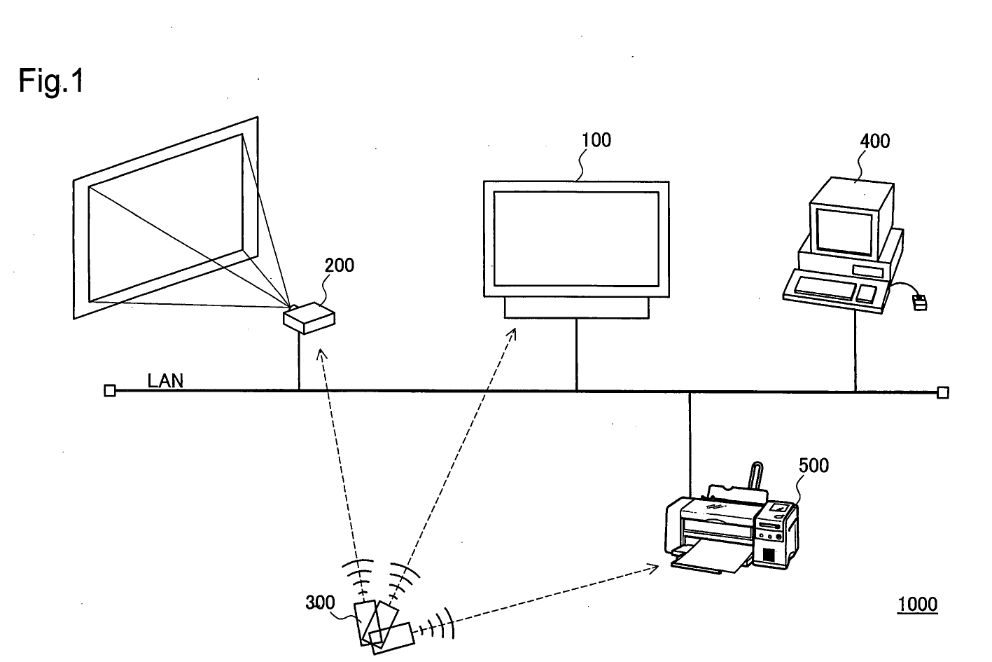

FIG. 1 shows the general configuration of a network control system 1000 embodying the invention. The network control system 1000 of this embodiment includes a TV receiver 100, a projector 200, an infrared remote control 300, a personal computer 400, and an inkjet printer (hereafter simply referred to as the printer) 500. The TV receiver 100, the projector 200, the personal computer 400, and the printer 500 are interconnected via a LAN (Local Area Network). Diversity of other network-connectable devices, for example, a video recorder, a DVD recorder, a speaker system, an air conditioner, and a refrigerator, may additionally connected to the LAN. A wired LAN is used in this embodiment but may be replaced by a wireless LAN according to the requirements.

In this network control system 1000, the user selects two desired devices for interconnected operation among the TV receiver 100, the projector 200, and the printer 500. The user then manipulates the infrared remote control 300 toward the two selected devices to specify these two selected devices as objects of interconnected operation. Each device specified as the object of interconnected operation receives an infrared signal sent from the infrared remote control 300 and executes a required series of control to attain the interconnected operation with the other specified device. The details of these devices and the related controls will be described later.

The TV receiver 100, the projector 200, and the printer 500 are available options to be operated in cooperation and all correspond to the devices of the invention. The personal computer 400 mediates control between devices specified by the user as objects of interconnected operation as discussed below and corresponds to the control device of the invention. In the description below, the personal computer 400 is referred to as the control device 400.

B. First Embodiment

A first embodiment of the invention regards interconnected operation between the TV receiver 100 and the projector 200.

B1. TV Receiver

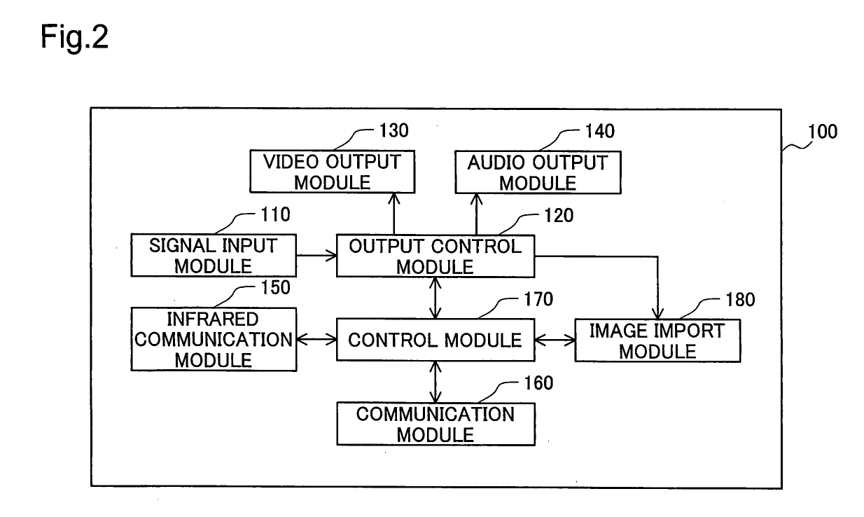

FIG. 2 schematically illustrates the configuration of the TV receiver 100. The TV receiver 100 has multiple functional blocks shown in FIG. 2.

A signal input module 110 inputs TV signals, video signals, and audio signals. An output control module 120 executes required series of signal processing with regard to the signals input into the signal input module 110 and outputs the processed signals in the form of an image to be displayed on a video output module 130 or in the form of sound to an audio output module 140.

An infrared communication module 150 has an infrared receiver transmitter to receive and transmit infrared signals from and to the infrared remote control 300. In the structure of the first embodiment, the infrared communication module 150 receives from the infrared remote control 300 a specification signal of specifying the TV receiver 100 as an object device of interconnected operation and an ID output request signal of requesting output of an ID as identification information for identification of the TV receiver 100. The infrared communication module 150 recognizes specification of the TV receiver 100 as an object device of interconnected operation, and sends back the ID of the TV receiver 100 to the infrared remote control 300 in response to reception of the ID output request signal sent from the infrared remote control 300 as control to allow for interconnected operation with another device. The infrared communication module 150 corresponds to the detection module and the identification information output module of the invention.

A communication module 160 establishes communication with another device via the LAN to transmit various data to and from another device. In the structure of the first embodiment, the communication module 160 receives an ID of the projector 200 and a video data output request signal from the projector 200 and sends back video data to the projector 200 in response to the received video data output request signal. The communication module 160 corresponds to the interconnected device identification information reception module, the output request reception module, and the data transmission module of the invention.

A control module 170 is constructed as a microcomputer including a CPU and memories and controls the operations of the infrared communication module 150, the communication module 160, an image import module 180, and the output control module 120. The image import module 180 imports the image displayed on the video output module 130 from the output control module 120 in response to a command from the control module 170, and generates image data. The generated image data is sent to the printer 500 for printing as described later.

B2. Projector

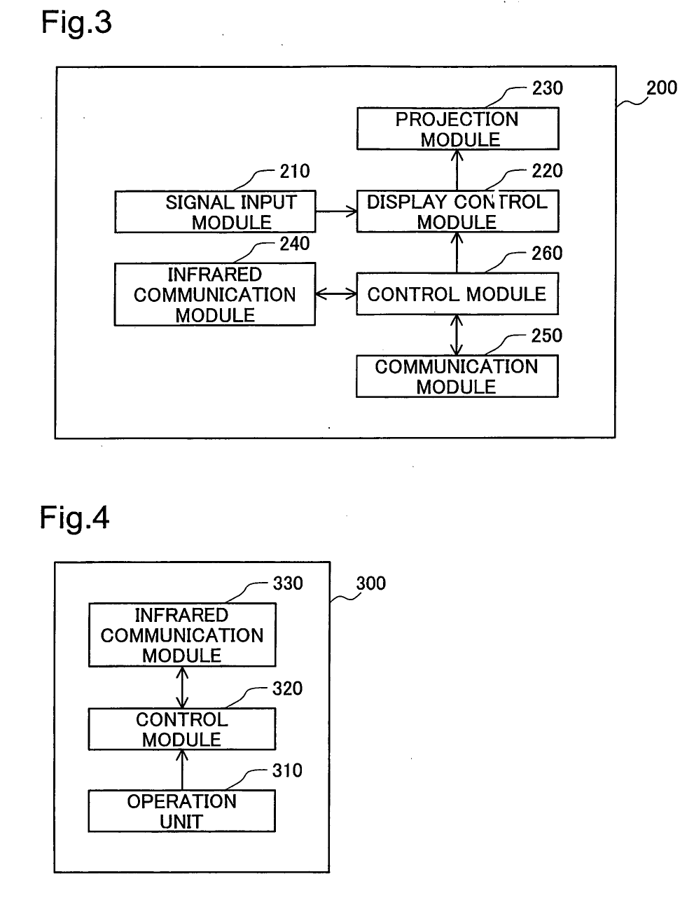

FIG. 3 schematically illustrates the configuration of the projector 200. The projector 200 has multiple functional blocks shown in FIG. 3.

A signal input module 210 inputs video signals and image signals. A display control module 220 executes required series of image processing with regard to the video signals and image signals input into the signal input module 210 and video data received from the TV receiver 100 via a communication module 250 and generates image data representing a processed image to be projected. A projection module 230 includes a light source unit and a projection optical system and projects a resulting image on a screen according to the image data generated by the display control module 220.

An infrared communication module 240 has an infrared receiver transmitter to receive and transmit infrared signals from and to the infrared remote control 300. In the structure of the first embodiment, the infrared communication module 240 receives from the infrared remote control 300 a specification signal of specifying the projector 200 as an object device of interconnected operation and an ID of another device of interconnected operation, for example, the ID of the TV receiver 100. The infrared communication module 240 corresponds to the detection module and the interconnected device identification information reception module of the invention.

The communication module 250 establishes communication with another device via the LAN to transmit various data to and from another device. In the structure of the first embodiment, the communication module 250 receives video data from the TV receiver 100. The communication module 250 sends the ID of the projector 200 to the TV receiver 100 as control to allow for interconnected operation with the TV receiver 100, while sending the video data output request signal to the TV receiver 100. The communication module 250 corresponds to the data reception module, the identification information output module, and the send request transmission module of the invention.

A control module 260 is constructed as a microcomputer including a CPU and memories, and controls the operations of the display control module 220, the infrared communication module 240, and the communication module 250.

B3. Infrared Remote Control

FIG. 4 schematically illustrates the configuration of the infrared remote control 300. The infrared remote control 300 has multiple functional blocks shown in FIG. 4. The infrared remote control 300 is, for example, a cell phone having infrared communication functions.

An operation unit 310 has an operation button that is manipulated by the user to specify a desired device as an object of interconnected operation.

An infrared communication module 330 has an infrared receiver transmitter to receive and transmit infrared signals from and to another device. In the structure of the first embodiment, the infrared communication module 330 sends a specification signal of specifying a certain device as an object of interconnected operation, an ID output request signal of requesting output of an ID of the certain device, and an ID of another device as another object of interconnected operation to the certain device located in the direction pointed by the infrared remote control 300. The infrared communication module 330 receives the ID of the certain device output in response to the ID output request signal. The infrared communication module 330 corresponds to the specification signal transmission module and the identification information reception module of the invention.

A control module 320 is constructed as a microcomputer including a CPU and memories and controls the operations of the infrared communication module 330 in response to the user's manipulation of the operation unit 310. For example, the control module 320 changes over the signal to be sent from the infrared communication module 330 according to the user's manipulation of the operation unit 310. In the structure of the first embodiment, the signal to be sent is changed over in response to an operation of ‘giving a long press of the operation button’ or an operation of ‘releasing the long-pressed operation button’. The structure of changing over the signal to be sent from the infrared communication module 330 according to the user's manipulation of the operation unit 310 requires only one operation button. This desirably simplifies the structure of the operation unit 310.

B4. Network Control

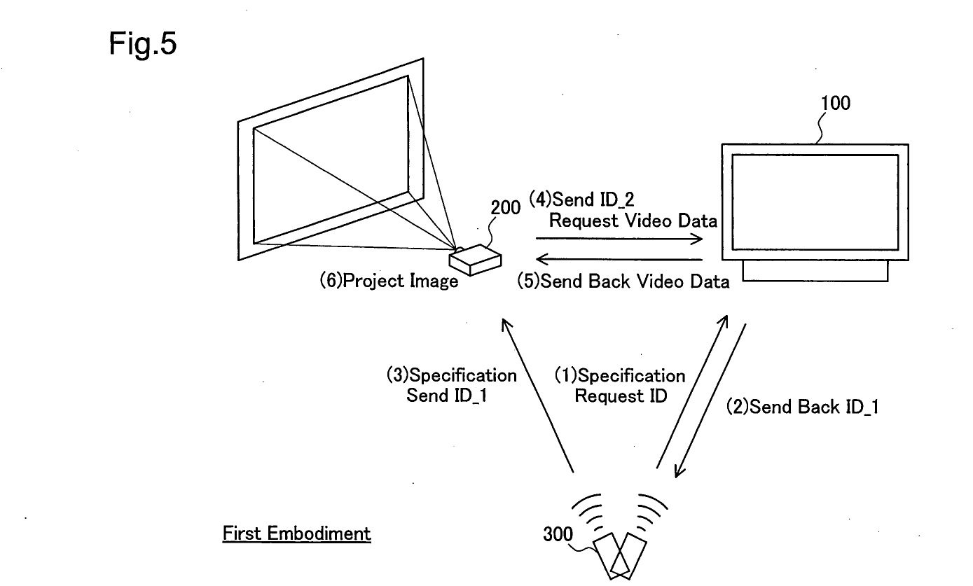

FIG. 5 shows the outline of network control in the first embodiment.

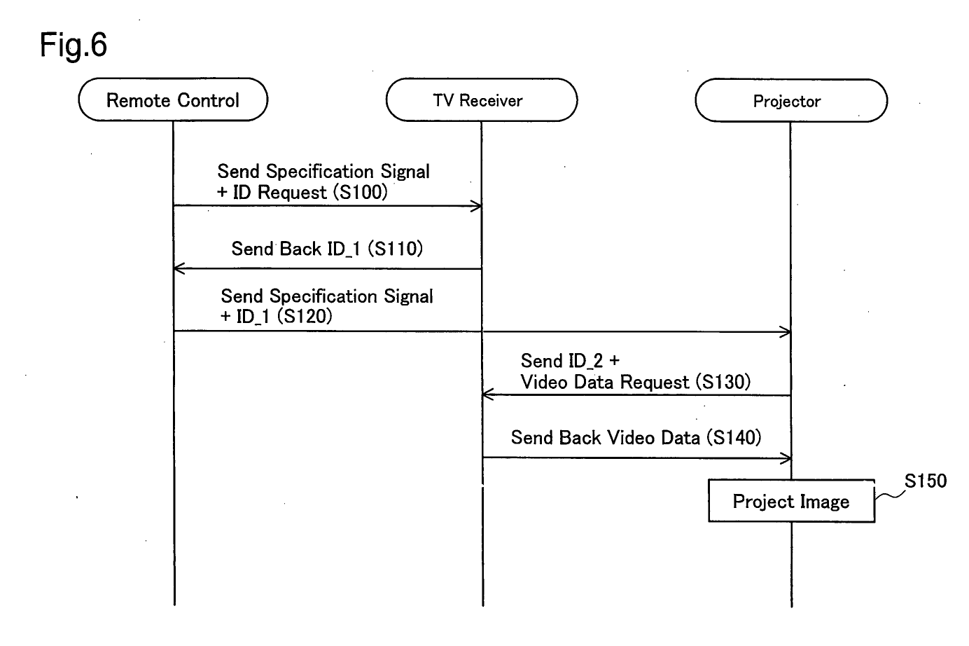

FIG. 6 is a flowchart showing a network control routine executed in the first embodiment. The network control of the first embodiment is described with reference to FIGS. 5 and 6.

When the user points the infrared remote control 300 toward the TV receiver 100 and long-presses the operation button on the infrared remote control 300, the infrared remote control 300 sends an ID output request signal and a specification signal for recognition of the specification as an object device of interconnected operation to the TV receiver 100 (process (1) in FIG. 5 and step S100 in FIG. 6).

The TV receiver 100 receives the specification signal and the ID output request signal and sends back an ID ‘ID_1’ of the TV receiver 100 to the infrared remote control 300 as control to allow for interconnected operation between specified devices (process (2) in FIG. 5 and step S110 in FIG. 6). During this process, the user continues pressing the operation button on the infrared remote control 300.

When the user redirects the infrared remote control 300 toward the projector 200 and releases the operation button, the infrared remote control 300 sends the ID ‘ID_1’ received from the TV receiver 100 and a specification signal for recognition of the specification as an object device of interconnected operation to the projector 200 (process (3) in FIG. 5 and step s120 in FIG. 6).

The projector 200 receives the specification signal and the ID ‘ID_1’ and sends an ID ‘ID_2’ of the projector 200 and a video data output request signal via the LAN to the TV receiver 100 corresponding to the received ID ‘ID_1’ as control to allow for interconnected operation between the specified devices (process (4) in FIG. 5 and step S130 in FIG. 6). Transmission of the ID ‘ID_2’ of the projector 200 to the TV receiver 100 notifies the TV receiver 100 of the specification of the projector 200 as an object device of interconnected operation. The TV receiver 100 thus recognizes the specification of the projector 200 as an object device of interconnected operation.

The TV receiver 100 receives the ID ‘ID_2’ of the projector 200 and the video data output request signal and sends back video data via the LAN to the projector 200 corresponding to the received ID ‘ID_2’ (process (5) in FIG. 5 and step S140 in FIG. 6).

The projector 200 receives the video data from the TV receiver 100. and projects an image according to the received video data (process (6) in FIG. 5 and step S150 in FIG. 6).

As described above, in the network control of the first embodiment, the user simply operates the infrared remote control 300 toward the TV receiver 100 and the projector 200 to specify multiple devices as desired objects of interconnected operation. This arrangement enables the user to intuitively specify desired devices as objects of interconnected operation without using any special operation window.

C. Second Embodiment

A second embodiment of the invention also regards interconnected operation between the TV receiver 100 and the projector 200, like the first embodiment. The differences from the first embodiment are that the infrared remote control 300 is only used to send specification signals but does not transmit IDs and that the projector 200 does not send a video data output request signal to the TV receiver 100.

C1. Respective Devices

The following description regards only the functions of the TV receiver 100, the projector 200, and the infrared remote control 300 in the second embodiment that are different from those in the first embodiment.

In the structure of the second embodiment, the infrared communication module 150 of the TV receiver 100 functions to receive a specification signal of specifying the TV receiver 100 as an object device of interconnected operation from the infrared remote control 300. The communication module 160 functions to receive the ID of the projector 200 from the projector 200. The communication module 160 also functions to send the ID of the TV receiver 100 to another device by broadcast as control to allow for interconnected operation with another device, while functioning to send video data to the projector 200 in response to reception of the ID of the projector 200 from the projector 200.

The infrared communication module 240 of the projector 200 functions to receive a specification signal of specifying the projector 200 as an object device of interconnected operation from the infrared remote control 300. The communication module 250 functions to receive the ID of the TV receiver 100 sent by broadcast and video data from the TV receiver 100. The communication module 250 also functions to send the ID of the projector 200 to the TV receiver 100 as control to allow for interconnected operation with the TV receiver 100.

The infrared communication module 330 of the infrared remote control 300 functions to send a specification signal of specifying each device, which is located in the direction pointed by the infrared remote control 300, as an object of interconnected operation.

C2. Network Control

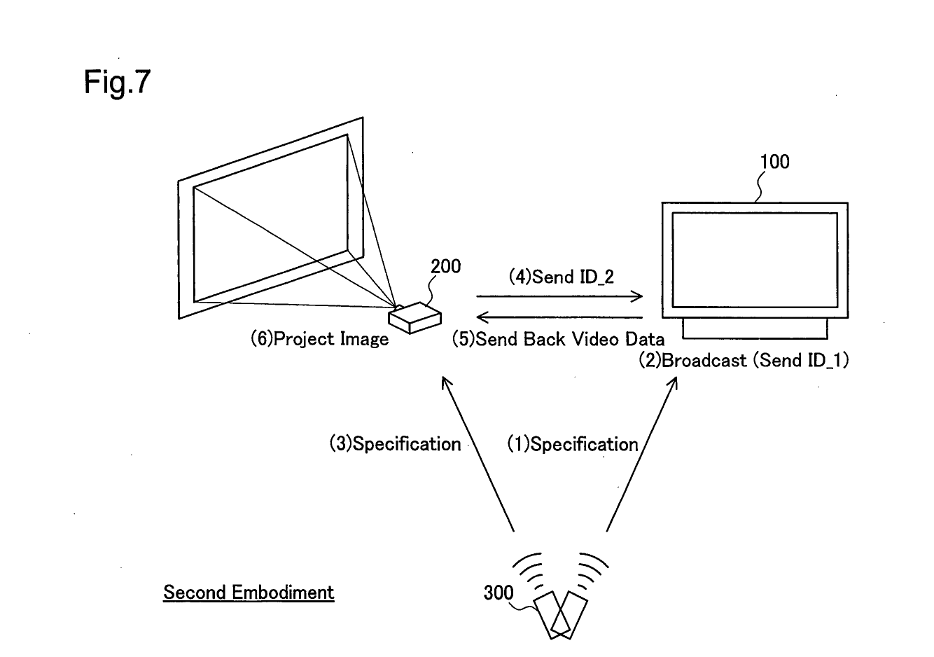

FIG. 7 shows the outline of network control in the second embodiment. The flows of network control in the second and subsequent embodiments are clearly understandable from the respective outlines of network control shown in FIG. 7 and subsequent drawings and are thus not described specifically with reference to corresponding flowcharts.

When the user directs the infrared remote control 300 toward the TV receiver 100 and presses the operation button on the infrared remote control 300, the infrared remote control 300 sends a specification signal for recognition of the specification as an object device of interconnected operation to the TV receiver 100 (process (1)).

The TV receiver 100 receives the specification signal and sends the ID ‘ID_1’ of the TV receiver 100 to all the devices connecting with LAN by broadcast as control to allow for interconnected operation between specified devices (process (2)). In this process, the TV receiver 100 may alternatively send the ID ‘ID_1’ by multicast.

The user then redirects the infrared remote control 300 toward the projector 200 and presses the operation button on the infrared remote control 300. The infrared remote control 300 sends a specification signal for recognition of the specification as an object device of interconnected operation to the projector 200 (process (3)).

The projector 200 receives the specification signal and sends the ID ‘ID_2’ of the projector 200 via the LAN to the TV receiver 100 corresponding to the ID ‘ID_1’ received by broadcast from the TV receiver 100 (process (4)). The TV receiver 100 accordingly recognizes the requirement of interconnected operation with the projector 200.

The TV receiver 100 receives the ID ‘ID_2’ and sends back video data via the LAN to the projector 200 corresponding to the received ID ‘ID_2’ (process (5)).

The projector 200 receives the video data from the TV receiver 100 and projects an image corresponding to the received video data (process (6)).

As described above, like the network control of the first embodiment, the network control of the second embodiment enables the user to intuitively specify desired devices as objects of interconnected operation without using any special operation window. The TV receiver 100 sends video data to the projector 200 without receiving a video data output request signal from the projector 200. The projector 200 receives video data from the TV receiver 100 and projects a corresponding image without sending the video data output request signal to the TV receiver 100.

D. Third Embodiment

A third embodiment of the invention also regards interconnected operation between the TV receiver 100 and the projector 200, like the first and the second embodiments. In the structure of the third embodiment, the control device 400 mediates control of interconnected operation between the TV receiver 100 and the projector 200.

D1. Respective Devices

The following description regards only the functions of the TV receiver 100 and the projector 200 in the third embodiment that are different from those in the second embodiment. The infrared remote control 300 of the third embodiment has the identical functions with those of the second embodiment. The functions of the control device 400 are described later.

In the structure of the third embodiment, the communication module 160 of the TV receiver 100 functions to receive specification information, which represents a specification of control to be executed in the TV receiver 100, from the control device 400. The communication module 160 also functions to send the ID of the TV receiver 100 to the control device 400 and to send video data to the projector 200 as control to allow for interconnected operation with another device.

The communication module 250 of the projector 200 functions to receive video data from the TV receiver 100. The communication module 250 also functions to send the ID of the projector 200 to the control device 400 as control to allow for interconnected operation with another device.

D2. Control Device

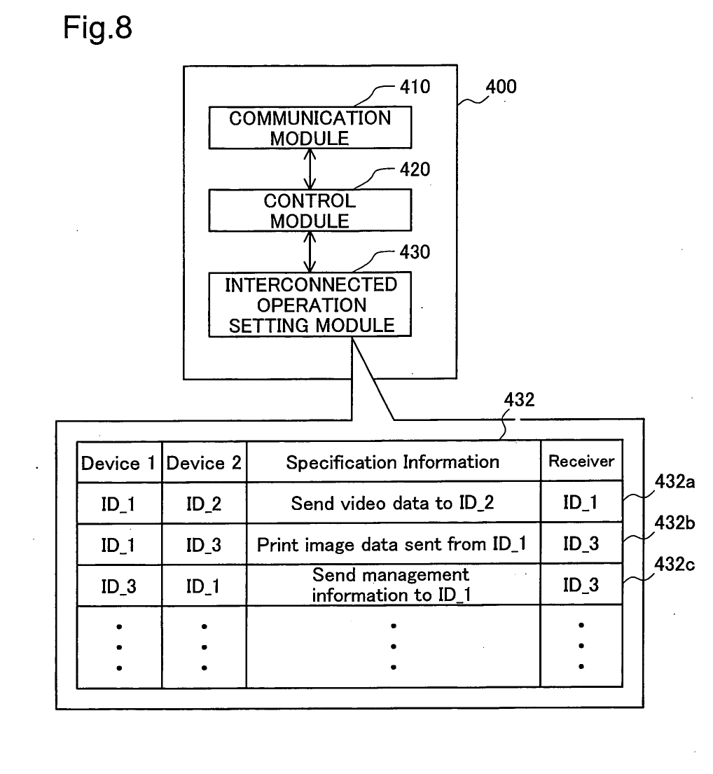

FIG. 8 schematically illustrates the configuration of the control device 400. The control device 400 has multiple functional blocks shown in FIG. 8.

A communication module 410 establishes communication with another device via the LAN and transmits various data to and from another device. The communication module 410 receives the IDs sent from the TV receiver 100 and from the projector 200. The communication module 410 also sends specification information, which represents a specification of control set by an interconnected operation setting module 430, to the TV receiver 100 or to the projector 200.

A control module 420 controls the operations of the communication module 410 and the interconnected operation setting module 430.

The interconnected operation setting module 430 has a specification information table 432 as shown in FIG. 8. The interconnected operation setting module 430 refers to the specification information table 432 and sets a specification of interconnected operation between devices corresponding to multiple IDs received by the communication module 410. The specification information table 432 has the user's registration of each piece of specification information corresponding to each combination of IDs allocated to multiple devices and a receiver of the piece of specification information. For example, a row 432a of the specification information table 432 shows that, in response to reception of IDs ‘ID_1’ and ‘ID_2’, the communication module 410 sends specification information representing ‘Send video data to ID_2’ to the receiver ‘ID_1’.

D3. Network Control

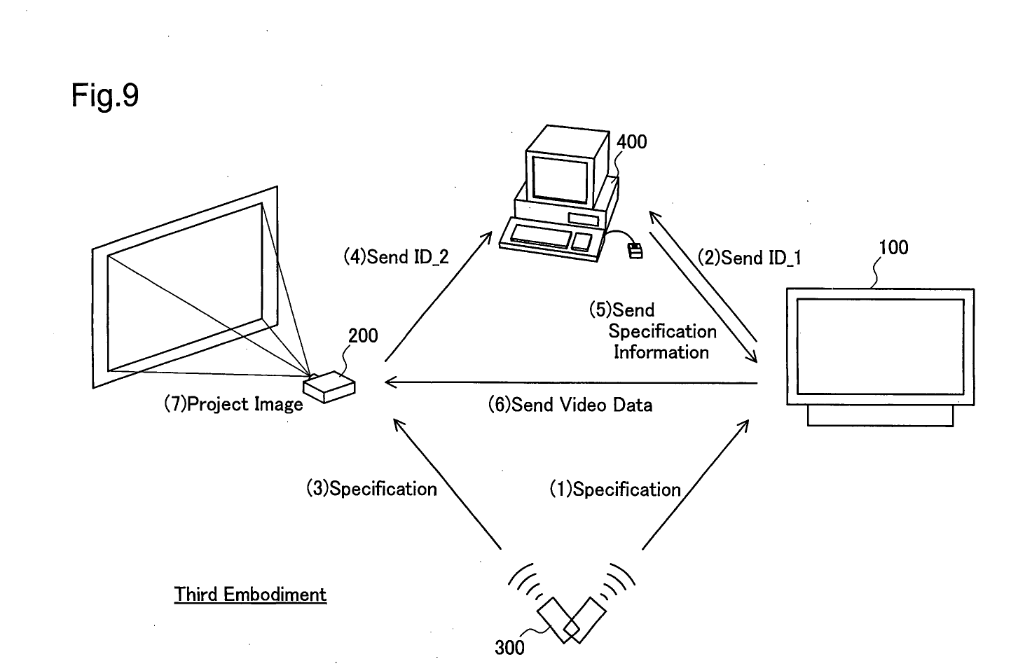

FIG. 9 shows the outline of network control in the third embodiment.

When the user directs the infrared remote control 300 toward the TV receiver 100 and presses the operation button on the infrared remote control 300, the infrared remote control 300 sends a specification signal for recognition of the specification as an object device of interconnected operation to the TV receiver 100 (process (1)).

The TV receiver 100 receives the specification signal and sends the ID ‘ID_1’ of the TV receiver 100 via the LAN to the control device 400 as control to allow for interconnected operation between specified devices (process (2)).

The user then redirects the infrared remote control 300 toward the projector 200 and presses the operation button on the infrared remote control 300. The infrared remote control 300 sends a specification signal for recognition of the specification as an object device of interconnected operation to the projector 200 (process (3)).

The projector 200 receives the specification signal and sends the ID ‘ID_2’ of the projector 200 via the LAN to the control device 400 as control to allow for interconnected operation between specified devices (process (4)).

The control device 400 receives the IDs ‘ID_1’ and ‘ID_2’, retrieves the specification information table 432 of FIG. 8 corresponding to the received pair of IDs ‘ID_1’ and ‘ID_2’ to extract a piece of specification information on a row 432a (Send video data to the projector 200 of ‘ID_2’), and sends the extracted specification information to the TV receiver 100 of ‘ID_1’ via the LAN (process (5)).

The TV receiver 100 receives the specification information from the control device 400, analyzes the received specification information, and sends video data to the projector 200 via the LAN (process (6)).

The projector 200 receives the video data from the TV receiver 100 and projects an image corresponding to the received video data (process (7)).

As described above, like the network control of the first embodiment, the network control of the third embodiment enables the user to intuitively specify desired devices as objects of interconnected operation without using any special operation window. The control device 400 mediates the interconnected operation between multiple devices specified by the user. This arrangement desirably relives the process load of each device.

E. Fourth Embodiment

A fourth embodiment of the invention regards interconnected operation between the TV receiver 100 and the printer 500. In the structure of the fourth embodiment, the control device 400 mediates control of interconnected operation between the TV receiver 100 and the printer 500.

E1. Respective Devices

The following description regards only the functions of the TV receiver 100 and the control device 400 in the fourth embodiment that are different from those in the third embodiment. The infrared remote control 300 of the fourth embodiment has the identical functions with those of the second and the third embodiments. The functions of the printer 500 are described later.

In the structure of the fourth embodiment, the communication module 160 of the TV receiver 100 sends the ID of the TV receiver 100 and image data generated by the image import module 180 to the control device 400 as control to allow for interconnected operation with another device.

The communication module 410 of the control device 400 functions to receive the IDs sent from the TV receiver 100 and from the printer 500, as well as the image data sent from the TV receiver 100. The communication module 410 also functions to send the image data received from the TV receiver 100 to the printer 500.

E2. Printer

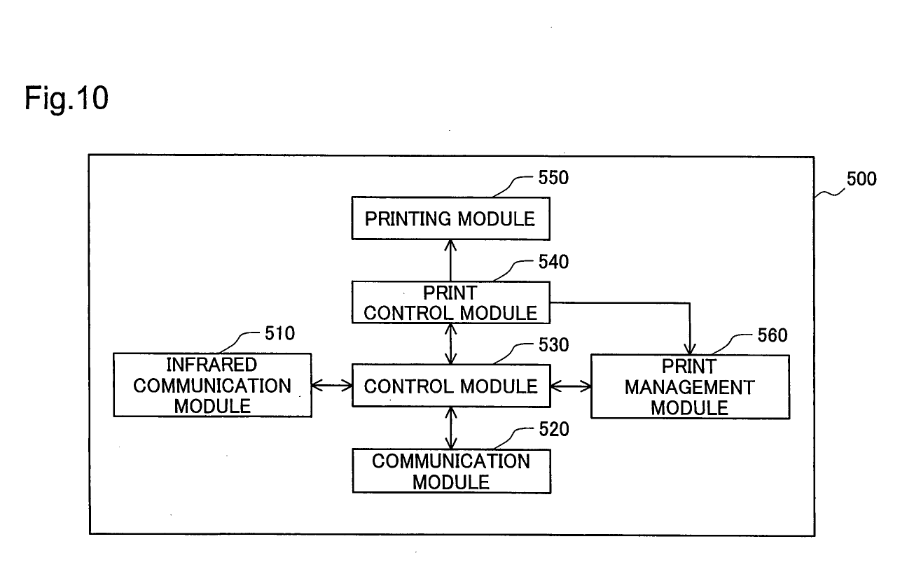

FIG. 10 schematically illustrates the configuration of the printer 500. The printer 500 has multiple functional blocks shown in FIG. 10.

An infrared communication module 510 has an infrared receiver transmitter to receive and transmit infrared signals from and to the infrared remote control 300. In the structure of the fourth embodiment, the infrared communication module 510 receives a specification signal of specifying the printer 500 as an object device of interconnected operation from the infrared remote control 300. The infrared communication module 510 corresponds to the detection module of the invention.

A communication module 520 establishes communication with another device via the LAN to transmit various data to and from another device. In the structure of the fourth embodiment, the communication module 520 receives image data generated by the image import module 180 of the TV receiver 100 from the control device 400. The communication device 520 also sends the ID of the printer 500 to the control device 400 as control to allow for interconnected operation with another device. The communication module 520 corresponds to the data reception module and the identification information output module of the invention.

A control module 530 controls the operations of the infrared communication module 510, the communication module 520, a print control module 540, and a print management module 560. The print control module 540 executes series of image processing including color conversion and halftoning with regard to the image data received by the communication module 520 and generates the processed image data as print data. A printing module 550 has a print head and a paper feed mechanism and executes printing according to the print data generated by the print control module 540. The print management module 560 manages and stores specific pieces of management information including a print record and residual quantities of inks.

E2. Network Control

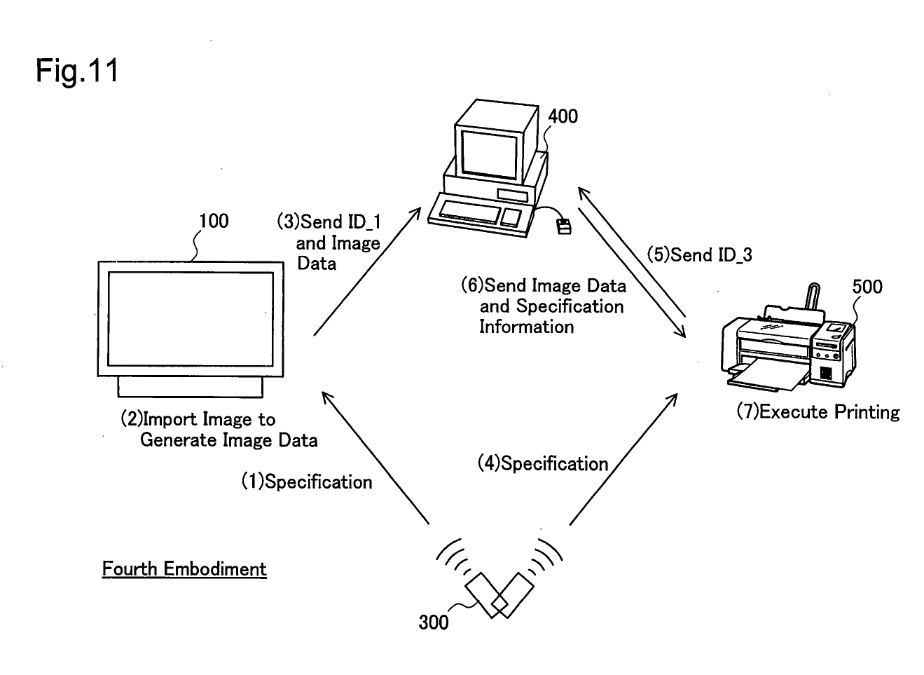

FIG. 11 shows the outline of network control in the fourth embodiment.

When the user directs the infrared remote control 300 toward the TV receiver 100 and presses the operation button on the infrared remote control 300, the infrared remote control 300 sends a specification signal for recognition of the specification as an object device of interconnected operation to the TV receiver 100 (process (1)).

The TV receiver 100 receives the specification signal and activates the image import module 180 to import a displayed image and generate image data representing the imported image as control to allow for interconnected operation between specified devices (process (2)). The TV receiver 100 then sends the generated image data and the ID ‘ID_1’ of the TV receiver 100 via the LAN to the control device 400 (process (3)).

The user then redirects the infrared remote control 300 toward the printer 500 and presses the operation button on the infrared remote control 300. The infrared remote control 300 sends a specification signal for recognition of the specification as an object device of interconnected operation to the printer 500 (process (4)).

The printer 500 receives the specification signal and sends back the ID ‘ID_3’ of the printer 500 via the LAN to the control device 400 as control to allow for interconnected operation between specified devices (process (5)).

The control device 400 receives the IDs ‘ID_1’ and ‘ID_3’ in this order, retrieves the specification information table 432 of FIG. 8 corresponding to the received IDs ‘ID_1’ and ‘ID_3’ and the reception order of the IDs to extract a piece of specification information on a row 432b (Print image data sent from the TV receiver 100 of ID_1), and sends the extracted piece of specification information and the image data received from the TV receiver 100 via the LAN to the printer 500 of ‘ID_3’ (process (6)).

The printer 500 receives the specification information and the image data, analyzes the specification information, and executes printing of the received image data (process (7)).

F. Fifth Embodiment

A fifth embodiment of the invention also regards interconnected operation between the TV receiver 100 and the printer 500, like the fourth embodiment. In the structure of the fifth embodiment, the control device 400 mediates control of interconnected operation between the TV receiver 100 and the printer 500. The order of specification of object devices through the user's operation of the infrared remote control 300 in the fifth embodiment is different from that in the fourth embodiment.

F1. Respective Device

The following description regards only the functions of the TV receiver 100, the control device 400, and the printer 500 in the fifth embodiment that are different from those in the fourth embodiment. The infrared remote control 300 of the fifth embodiment has the identical functions with those of the second to the fourth embodiments.

In the structure of the fourth embodiment, the communication module 160 of the TV receiver 100 functions to receive management information, which is under management of the printer 500, from the printer 500. The communication module 160 also functions to send the ID of the TV receiver 100 to the control device 400 as control to allow for interconnected operation with another device.

The communication module 410 of the control device 400 functions to receive the IDs sent from the TV receiver 100 and from the printer 500. The communication module 410 also functions to send specification information set by the interconnected operation setting module 430 to the printer 500.

The communication module 520 of the printer 500 functions to receive the specification information from the control device 400. The communication module 520 also functions to send the ID of the printer 500 to the control device 400 and to send the management information to the TV receiver 100 as control to allow for interconnected operation with another device.

F2. Network Control

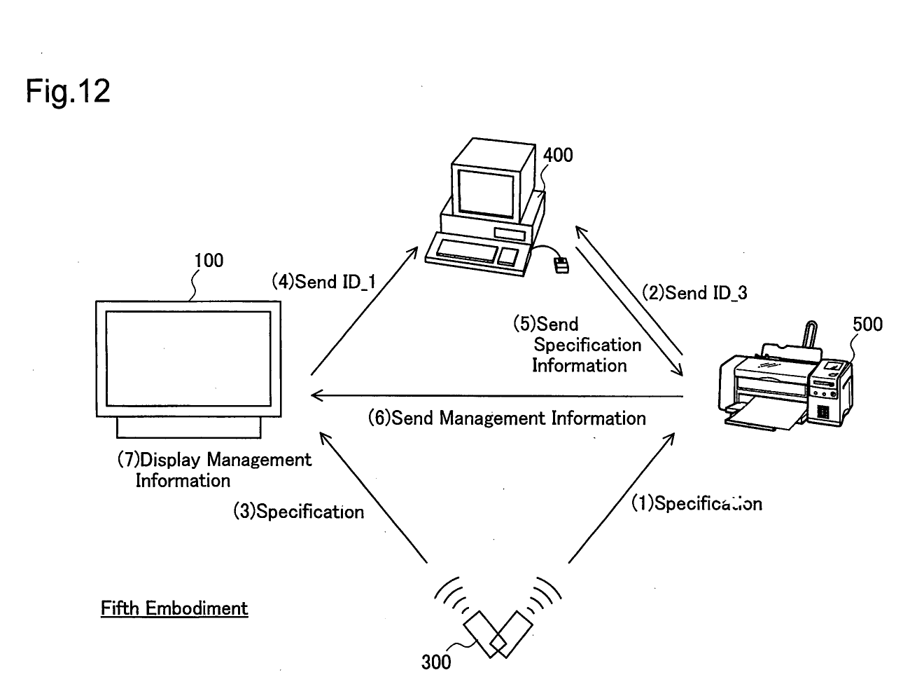

FIG. 12 shows the outline of network control in the fifth embodiment.

When the user directs the infrared remote control 300 toward the printer 500 and presses the operation button on the infrared remote control 300, the infrared remote control 300 sends a specification signal for recognition of the specification as an object device of interconnected operation to the printer 500 (process (1)).

The printer 500 receives the specification signal and sends the ID ‘ID_3’ of the printer 500 via the LAN to the control device 400 as control to allow for interconnected operation between specified devices (process (2)).

The user then redirects the infrared remote control 300 toward the TV receiver 100 and presses the operation button on the infrared remote control 300. The infrared remote control 300 sends a specification signal for recognition of the specification as an object device of interconnected operation to the TV receiver 100 (process (3)).

The TV receiver 100 receives the specification signal and sends the ID ‘ID_1’ of the TV receiver 100 via the LAN to the control device 400 as control to allow for interconnected operation between specified devices (process (4)).

The control device 400 receives the IDs ‘ID_3’ and ‘ID_1’ in this order, retrieves the specification information table 432 of FIG. 8 corresponding to the received IDs and the reception order of the IDs to extract a piece of specification information on a row 432c (Send management information to the TV receiver 100 of ID_1), and sends the extracted piece of specification information via the LAN to the printer 500 of ID_3 (process (5)).

The printer 500 receives the specification information, analyzes the received specification information, and sends the management information under management of the print management module 560 to the TV receiver 100 via the LAN (process (6)).

The TV receiver 100 receives the management information and displays the received management information (process (7)).

As described above, like the network control of the first embodiment, the network controls of the fourth and the fifth embodiments enable the user to intuitively specify desired devices as objects of interconnected operation without using any special operation window. The specification of the control is changed over with a variation in specification order of devices as objects of interconnected operation.

G. Modifications

The embodiments discussed above are to be considered in all aspects as illustrative and not restrictive. There may be many modifications, changes, and alterations without departing from the scope or spirit of the main characteristics of the present invention. Some examples of possible modification are given below.

G1. Modified Example 1

In any of the above embodiments, the infrared remote control 300 is used to specify object devices of interconnected operation. The infrared remote control 300 is, however, not restrictive and may be replaced by any remote control that is capable of transmitting sound wave signals or radio signals having directional characteristic and a corresponding receiver that receives such sound wave signals or radio signals. The infrared remote control 300 may also be replaced by a touch sensor that detects the user's touch on each device, a switch operated for specification of each device, and a voice sensor that detects the user's voice for specification of each device. Any of such arrangements enables the user to intuitively specify desired devices as objects of interconnected operation through the user's operation of the remote control, the touch sensor, or the switch or by the user's voice.

G2. Modified Example 2

In the embodiments discussed above, the specification signals, the IDs, and the specification information are transmitted between respective devices. Such transmission is, however, not restrictive. One possible modification may display an operation window for operating each specified device on a certain device equipped with a display unit, for example, the TV receiver 100. For example, in the case where an image imported by the TV receiver 100 is to be printed by the printer 500, a window to specify settings of printing may be displayed on the TV receiver 100. When a cell phone having infrared communication functions is used for the infrared remote control 300, various operation windows may open on the monitor of the cell phone. This further enhances the convenience of the network control system 1000.

G3. Modified Example 3

The above embodiments regard the interconnected operation between the TV receiver 100 and the projector 200 and the interconnected operation between the TV receiver 100 and the printer 500. These are, however, only illustrative and not restrictive in any sense. The number of the object devices of interconnected operation is not restricted to two devices. In one modified network control system, a video recorder, a DVD recorder, and a speaker system are additionally connected to the LAN. The network control allows for interconnected operation among the video recorder or the DVD recorder, the speaker system, and the projector 200.

All changes within the meaning and range of equivalency of the claims are intended to be embraced therein. The scope and spirit of the present invention are indicated by the appended claims, rather than by the foregoing description.

1. A network control system that enables interconnected operation between multiple devices connected to a network,
each of the multiple devices comprising:
a detection module that detects a user's predetermined operation toward the device as specification of the device as an object device of interconnected operation; and
a control module that executes a preset control to allow for interconnected operation between specified devices, in response to the detection.

2. A network control system in accordance with claim 1, wherein the detection module comprises at least one of a touch sensor that detects the user's touch, a switch that is manipulated by the user, a voice sensor that detects the user's voice, and a receiver that receives a signal with directional characteristic, which is sent from a preset remote control that is operated by the user and is capable of transmitting the signal with directional characteristic.

3. A network control system in accordance with claim 1, wherein the device further comprises:
an identification information output module that outputs identification information for identification of the device at a predetermined timing after the detection.

4. A network control system in accordance with claim 3, wherein the identification information output module outputs the identification information simultaneously with the detection.

5. A network control system in accordance with claim 3, wherein the device further comprises:
an output request reception module that receives an output request of the identification information from another device specified as another object device of interconnected operation, and
the identification information output module outputs the identification information, in response to reception of the output request.

6. A network control system in accordance with claim 1, wherein the device further comprises:
an interconnected device identification information reception module that receives interconnected device identification information for identifying another device specified as another object device of interconnected operation, from the another device, and
the control module executes the control, based on the received interconnected device identification information.

7. A network control system in accordance with claim 6, wherein the device receives preset data, while the another device sends the preset data,
the device further comprises:
a send request transmission module that transmits a send request of the preset data to the another device corresponding to the interconnected device identification information; and
a data reception module that receives the preset data, and
the another device comprises a data transmission module that sends the preset data, in response to the send request.

8. A network control system in accordance with claim 6, wherein the device sends preset data, while the another device receives the preset data,
the device further comprises a data transmission module that sends the preset data to the another device corresponding to the interconnected device identification information, and
the another device comprises a data reception module that receives the preset data.

9. A network control system in accordance with claim 3, the network control system further comprising:
a control device that works to enable interconnected operation of at least two object devices selected among the multiple devices,
the control device comprising:
an identification information input module that inputs pieces of the identification information output from the at least two object devices;
an interconnected operation setting module that specifies a setting of interconnected operation between the at least two object devices corresponding to the received pieces of the identification information; and
a specification information transmission module that sends specification information representing the specified setting of interconnected operation to at least one of the at least two object devices that respectively output the pieces of the identification information,
wherein the device further comprises a specification information reception module that receives the specification information, and
the control module executes the control, based on the received specification information.

10. A network control system in accordance with claim 1, the network control system further comprising a remote control that is capable of transmitting a signal with directional characteristic,
the remote control comprising:
an operation unit that is manipulated by the user to attain the user's predetermined operation toward the device; and
a specification signal transmission module that sends a preset specification signal to specify the device as an object device of interconnected operation, in response to the user's manipulation of the operation unit,
the device further comprises a specification signal reception module that receives the specification signal, and
the control module executes the control, based on the received specification signal.

11. A network control system in accordance with claim 10, wherein the specification signal transmission module selectively sends one of multiple specification signals according to a type of the user's manipulation of the operation unit.

12. A network control system in accordance with claim 11, wherein the multiple specification signals include a signal representing an order of specification of at least two devices as object devices of interconnected operation.

13. A network control system in accordance with claim 10, wherein the device further comprises an identification information output module that outputs identification information for identifying the device, and
the specification signal transmission module sends a request signal of requesting output of the identification signal.

14. A network control system in accordance with claim 13, wherein the remote control further comprises an identification information reception module that receives the identification information output from the device, which has received the specification signal, and
the specification signal transmission module sends the identification signal together with the specification signal, in response to the user's manipulation of the operation unit after the identification information reception module has received the identification information.

15. A device that is used in a network control system, which enables interconnected operation between a plurality of the devices connected to a network,
the device comprising:
a detection module that detects a user's predetermined operation toward the device as specification of the device as an object device of interconnected operation; and
a control module that executes a preset control to allow for interconnected operation between specified devices, in response to the detection.

16. A control device that is used in a network control system, which enables interconnected operation between multiple devices connected to a network,
the control device comprising:
an identification information input module that inputs pieces of identification information output from at least two object devices selected among the multiple devices to respectively identify the at least two object devices;
an interconnected operation setting module that specifies a setting of interconnected operation between the at least two object devices corresponding to the received pieces of the identification information; and
a specification information transmission module that sends specification information representing the specified setting of interconnected operation to at least one of the at least two object devices that respectively output the pieces of the identification information.

17. A remote control that is used in a network control system, which enables interconnected operation between multiple devices connected to a network, and is capable of transmitting a signal with directional characteristic,
the remote control comprising:
an operation unit that is manipulated by a user to attain the user's predetermined operation toward at least one of the multiple devices; and
a specification signal transmission module that sends a preset specification signal to specify the device as an object device of interconnected operation, in response to the user's manipulation of the operation unit.
